(19) United States
(12) Patent Application Publication
(10) Pub. No.: US 2013/0181169 A1
(43) Pub. Date: Jul. 18, 2013

(54) REFORMING OF HYDROCARBON GAS WITH SOLAR ENERGY

(71) Applicants: Hanna H. Klein, Jerusalem (IL); Shimon Klein, Jerusalem (IL)

(72) Inventors: Hanna H. Klein, Jerusalem (IL); Shimon Klein, Jerusalem (IL)

(21) Appl. No.: 13/348,657

(22) Filed: Jan. 12, 2012

(51) Int. Cl. C01B 3/38; B01J 7/00; C01B 3/26

(52) U.S. Cl. 252/373; 422/187; 422/162; 422/119; 422/129

(57) ABSTRACT

A method and system for reforming hydrocarbon gas, which includes stripping from the hydrocarbon gas at least most of gaseous impurities of a type and/or quantity which would normally interfere with efficient catalytic reforming in order to provide stripped hydrocarbon gas including carbon dioxide, optionally compressing the stripped hydrocarbon gas to provide compressed stripped hydrocarbon gas, and reacting the stripped hydrocarbon gas in a solar radiation receiving reactor having a catalyst that is heated by concentrated solar radiation impinging thereon, thereby providing an output gas mixture comprising hydrogen gas and carbon monoxide. The invention also includes a method and system for reforming hydrocarbons in a solar radiation receiver reactor, and such a system that also includes a certification system for certifying the amount and composition of the output gas mixture.

### FIELD OF THE INVENTION

The present invention relates to gas reforming generally.

### BACKGROUND OF THE INVENTION

The following publications, the disclosures of which are hereby incorporated by reference, are believed to represent the current state of the art:

U.S. Pat. Nos. 5,431,855; 5,508,014; 5,931,158; 6,003,508; 6,233,914; 6,321,539; 6,510,695; 6,516,794; 6,694,738; 6,824,682; 6,832,485

Anikeev, V. I., Parmon, V. N., Kirillov, V. A., and Zamaraev, K. I., 1990, “Theoretical and experimental studies of solar catalytic power plants based on reversible reactions with participation of methane and synthesis gas”, Int. J. of Hydrogen Energy 15(4):275-286.

Berman, A., Karn, R. K., Epstein, M., 2005, “Kinetics of steam reforming of methane on Ru/Al₂0₃ catalysts promoted with Mn oxides”. Applied catalysis A: General 282:73-83.

Berman, A., Karn, R. K., and Epstein, M., 2006, “A new catalyst system for high-temperature solar reforming of methane” Energy & Fuels 20:455-462.

Dewil, Raf., Appels, L., Baeyens, J. 2006, “Energy use of biogas hampered by the presence of siloxanes”, Energy Conversion and Management 47:1711-1722.

Diver, R. B., Fish, J. D., Levitan, R., Levy, M., Meirovitch, E., Rosin, H., Paripatyadar, S. A., and Richardson, J. T., 1992, “Solar test of an integrated sodium reflux heat pipe receiver/reactor for thermochemical energy transport” Solar Energy 48(1):21-30.

Fraenkel, D., Levitan, R., and Levy, M., 1986, “A solar thermochemical pipe based on the CO₂—CH₄(1:1) system”, Int. J. of Hydrogen Energy 11(4):267-277.

Klein, H. H., Karni, J., Rubin, R., 2009, “Dry Methane Reforming Without a Metal Catalyst in a Directly Irradiated Solar Particle Reactor” J. of Solar Energy Engineering, Vol. 131, 021001-1-14.

Kodama, T., Kiyama, A., Moriyama, T., and Mizuno, O., 2004, “Solar methane reforming using a new type of catalytically activated metallic foam absorber” J. of Solar Energy Engineering 126(May):808-811.

Kodama, T., Moriyama, T., Shimoyama, T., Gokon, N., Andou, H., Satou, N. 2006, “Ru/Ni—Mg—O catalyzed SiC-foam absorber for solar reforming receiver-reactor”, Journal of Solar Energy Engineering 128:318-325.

Kribus, A., Zaibel, R., Carey, D. Segal, A., Karni, T. 1998, “A solar-driven combined cycle power plant”, Solar Energy 62(2):121-129.

Levy, M., Rubin, R., Rosin, H., and Levitan, R., 1992, “Methane reforming by direct solar irradiation of the catalyst” Energy 17(8):749-756.

Mills, D., 2004, “Advances in solar thermal electricity technology”, Solar Energy 76:19-31.

Moeller, S., Kaucic, D., and Sattler, C., 2006, “Hydrogen production by Solar reforming of Natural Gas: A comparison of two possible process configurations” J. of Solar Energy Engineering 128:16-23.

Wang, X., Sun, T., Yang, J., Zhao, L., Jia, J. 2007, “Low-temperature H₂S removal from gas streams with SBA-15 supported ZnO nanoparticles”, Chemical Engineering Journal, doi:10.1016/j.cej.2007.11.013.

Woerner, A., and Tamme, R., 1998, “CO₂ reforming of methane in a solar driven volumetric receiver-reactor” Catalysis Today 46:165-174.

### SUMMARY OF THE INVENTION

The present invention seeks to provide improved methods and systems for reforming hydrocarbon gas, especially biogas.

There is thus provided in accordance with a preferred embodiment of the present invention a method for reforming hydrocarbon gas, which includes stripping from the hydrocarbon gas at least most of gaseous impurities selected from the group consisting of hydrogen sulfide, siloxanes, organic compounds other than hydrocarbons, and halogenated volatile organic compounds, in order to provide stripped hydrocarbon gas including carbon dioxide, and reacting the stripped hydrocarbon gas in a solar radiation receiving reactor having a catalyst that is heated by concentrated solar radiation impinging thereon, thereby providing an output gas mixture including hydrogen gas and carbon monoxide.

Preferably, the method also includes compressing the stripped hydrocarbon gas to provide compressed stripped hydrocarbon gas, followed by reacting the compressed stripped hydrocarbon gas in the solar radiation receiving reactor.

Preferably, the method also includes adding steam and/or carbon dioxide to the compressed stripped hydrocarbon gas when the molar ratio of carbon dioxide to hydrocarbon gas in the compressed stripped hydrocarbon gas is below a preferred molar ratio, thereby providing oxygen-enhanced stripped hydrocarbon gas for supply to the solar radiation receiving reactor.

Preferably, the solar radiation receiving reactor includes a solar radiation transparent window for allowing the solar radiation to impinge on the catalyst, and the method also includes cooling the solar radiation transparent window to help prevent deposition of carbon thereon.

Preferably, the stripping employs adsorption on at least one material selected from the group consisting of activated carbon, alumina, clay, ZnO nanoparticles, molecular sieves, or polymer beds. Additionally or alternatively, the stripping employs the use of water or a liquid catalyst containing ferric ions. Additionally Or alternatively, the stripping employs the use of a cold trap.

Preferably, the method also includes stripping excess water and/or excess carbon dioxide from the output gas mixture.

Preferably, the method also includes ascertaining the composition of the output gas mixture and controlling the flow rate of the output gas mixture.

There is also provided in accordance with another preferred embodiment of the present invention a system for reforming hydrocarbon gas, including a first stripping unit for stripping from the hydrocarbon gas at least most of gaseous impurities selected from the group consisting of hydrogen sulfide, siloxanes, volatile organic compounds other than hydrocarbons, and halogenated volatile organic compounds, in order to provide stripped hydrocarbon gas including CO₂, and a solar radiation receiving reactor for reacting the stripped hydrocarbon gas having a catalyst that is heated by concentrated solar radiation impinging thereon, thereby providing an output gas mixture including hydrogen gas and carbon monoxide.

Preferably, the system also includes a compressor for compressing the stripped hydrocarbon gas to provide compressed stripped hydrocarbon gas. The input to the solar radiation receiving reactor then is the compressed stripped hydrocarbon gas.

Preferably, the system also includes a conduit and a valve for adding steam and/or carbon dioxide to the compressed stripped hydrocarbon gas when the molar ratio of carbon dioxide to hydrocarbon gas in the compressed stripped hydrocarbon gas is below a preferred molar ratio, thereby to provide oxygen-enhanced stripped hydrocarbon gas for supply to the solar radiation receiving reactor.

Preferably, the solar radiation receiving reactor includes a solar radiation transparent window allowing the solar radiation to impinge on the catalyst, and the system also includes a mechanism for cooling the solar radiation transparent window to help prevent deposition of carbon thereon.

Preferably, the first stripping unit employs adsorption on at least one material selected from the group consisting of activated carbon, alumina, clay, ZnO nanoparticles, molecular sieves, or polymer beds. Additionally or alternatively, the first stripping unit employs the use of water or a liquid catalyst containing ferric ions. Additionally or alternatively, the first stripping unit employs the use of a cold trap.

Preferably, the system also includes a second stripping unit for stripping excess water and/or excess carbon dioxide from the output gas mixture.

Preferably, the system also includes a mechanism for ascertaining the chemical composition of the output gas mixture, and a flow controller for controlling the flow rate of the output gas mixture.

There is also provided in accordance with yet another preferred embodiment of the present invention a method for reforming hydrocarbon gas, which includes reacting hydrocarbon gas with steam and/or carbon dioxide in a solar radiation receiving reactor, which includes a catalyst and a solar radiation transparent window allowing concentrated solar radiation to impinge directly on the catalyst, thereby providing an output gas mixture including hydrogen gas and carbon monoxide. The method includes maintaining desired transparency of the window to the concentrated solar radiation by at least one of the following ways: controlling the molar ratio of hydrocarbon gas to steam and/or carbon dioxide in the reactor in order to provide a generally equal presence of hydrocarbon gas and steam and/or carbon dioxide by molar percentage, cooling the window, and causing the steam and/or carbon dioxide to flow alongside the window, generally to exclude the presence of the hydrocarbon gas thereat.

Preferably, the method includes ascertaining the composition of the output gas mixture and controlling the flow rate of the output gas mixture.

There is also provided in accordance with a different preferred embodiment of the present invention a system for reforming hydrocarbon gas including a solar radiation receiving reactor which includes a catalyst and a solar radiation transparent window allowing concentrated solar radiation to impinge directly on the catalyst, the reactor receiving hydrocarbon gas and steam and/or carbon dioxide and providing an output gas mixture including hydrogen gas and carbon monoxide, and functionality for maintaining desired transparency of the window to the concentrated solar radiation by at least one of the following ways: controlling the molar ratio of hydrocarbon gas to steam and/or carbon dioxide in the reaction to provide a generally equal presence of hydrocarbon gas and steam and/or carbon dioxide by molar percentage, cooling the window, and causing the steam and carbon dioxide to flow alongside the window, generally to exclude the presence of hydrocarbon gas thereat.

Preferably, the system also includes a mechanism for ascertaining the chemical composition of the output gas mixture, and a flow controller for controlling the flow rate of the output gas mixture.

There is also provided in accordance with another preferred embodiment of the present invention a system for reforming hydrocarbon gas, including a solar radiation receiving reactor that receives the hydrocarbon gas and also steam and/or carbon dioxide and provides an output gas mixture that includes hydrogen gas and carbon monoxide, and that also includes a certification system for certifying the amount and composition of the output gas mixture.

Preferably, the certification system includes a mechanism for ascertaining the composition of the output gas mixture and a flow controller for controlling the flow rate of the output gas mixture. Most preferably, the mechanism for ascertaining the composition of the output gas mixture includes a gas chromatograph and/or an infrared gas analyzer.

Preferably, the system for reforming hydrocarbon gas also includes a tamper-proof housing for securing the certification system.

### BRIEF DESCRIPTION OF THE DRAWINGS

The present invention will be understood and appreciated more fully from the following detailed description, taken in conjunction with the drawings in which:

FIG. 1 is a simplified partially block diagram, partially schematic illustration of a system for reforming biogas, constructed and operative in accordance with a preferred embodiment of the present invention; and

FIG. 2A is a simplified partially block diagram, partially schematic illustration of a system for reforming hydrocarbon gas, constructed and operative in accordance with a preferred embodiment of the present invention; and

FIG. 2B is a simplified partially block diagram, partially schematic illustration of a system for reforming hydrocarbon gas, constructed and operative in accordance with another preferred embodiment of the present invention.

### DETAILED DESCRIPTION OF PREFERRED EMBODIMENTS

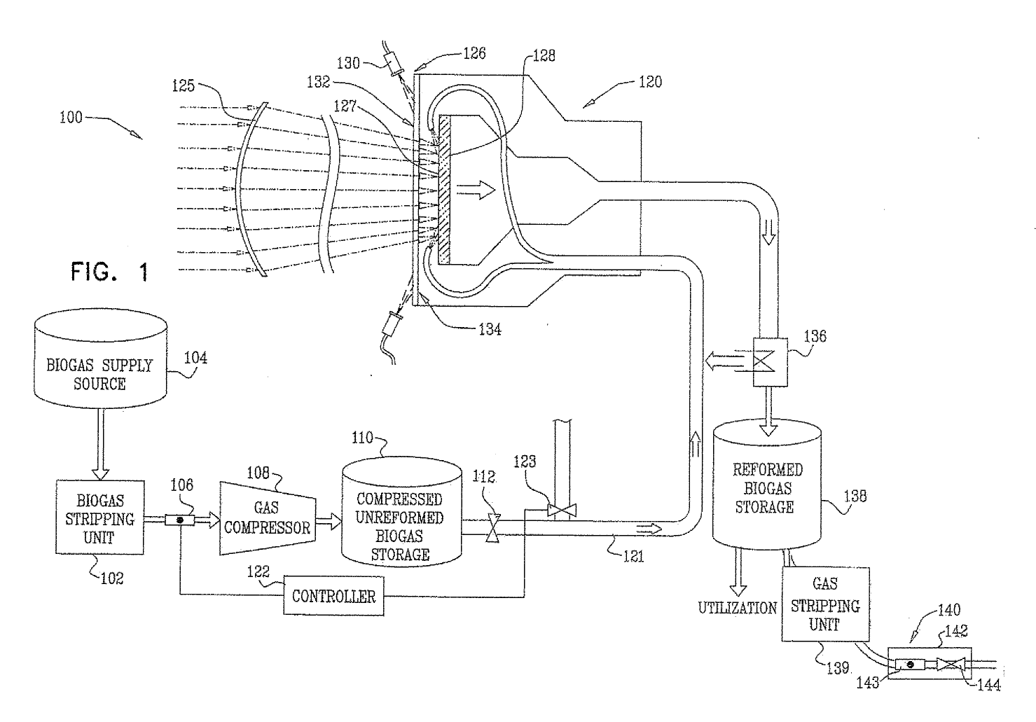

Reference is now made to FIG. 1, which is a simplified partially block diagram, partially schematic illustration of a system for reforming biogas, constructed and operative in accordance with a preferred embodiment of the present invention.

As seen in FIG. 1, the present invention provides a system 100 for reforming biogas including a biogas stripping unit 102, which receives biogas from a biogas supply source 104. For the purpose of the present specification and claims, the term “biogas” is taken to mean any gas or mixture of gases which includes a hydrocarbon gas and gaseous impurities of a type and/or quantity which would normally interfere with efficient catalyzed reforming. Thus, it is appreciated that the term “biogas” as used herein is broader than the conventional term which refers only to non-fossil fuel hydrocarbon gases.

A preferred embodiment of the present invention is capable of reforming, e.g. increasing the calorific value, of biogas which includes a significant amount of carbon dioxide and significant amounts of gaseous impurities. The present invention employs solar energy for this purpose.

In a preferred embodiment of the present invention, the biogas supply source 104 is a storage tank which receives biogas from any one or more of various biogas sources, examples of which include: landfills, biomass gasifiers, such as charcoal manufacturing facilities and municipal organic waste, and anaerobic digesters which process waste such as sewage sludge, manure, agricultural waste, forestry waste, animal slaughter, food processing waste, water treatment waste, and municipal organic waste. A typical chemical composition of the biogas is shown in Table 1.

TABLE 1

| | |
|---|---|
| Gas | Concentration |

| | | |
|---|---|---|
| CH₄ or other hydrocarbons | 25-75 | mol % |
| CO₂ | 25-75 | mol % |
| H₂S | 500-5000 | ppm |
| H₂O | 1-2 | mol % |
| SILOXANE (when biogas originates from | 2-200 | mg/m³ |
| landfill, municipal waste or sewage sludge) | | |

| | |
|---|---|
| VOLATILE ORGANIC COMPOUNDS | ppm level |
| OTHER THAN HYDROCARBONS | |
| HALOGENATED VOLATILE ORGANIC | ppm-ppb level |
| COMPOUNDS | |

Biogas stripping unit 102 preferably comprises multiple subunits such as described inter cilia in the above-referenced publications of Wang, X., Sun, T., Yang, J., Zhao, L., Jia, J. 2007, “Low-temperature H₂S removal from gas streams with. SBA-15 supported ZnO nanoparticles”, Chemical Engineering Journal, doi:10.1016/j.cej.2007.11.013, Dewil, Raf., Appels, L., Baeyens, J. 2006, “Energy use of biogas hampered by the presence of siloxanes”, Energy Conversion and Management 47:1711-1722, and U.S. Pat. No. 5,508,014, the disclosures of which are hereby incorporated by reference. Biogas stripping unit 102 is operative for stripping H₂S, siloxanes, VOCs (volatile organic compounds), HVOCs (halogenated volatile organic compounds), and steam from biogas, without affecting biogas carbon dioxide levels. Biogas stripping unit 102 is operative for stripping H₂S from biogas preferably by adsorption on porous materials such as activated carbon, alumina, clay or ZnO nanoparticles, or by use of water or a liquid catalyst containing ferric ions; biogas stripping unit 102 is operative for stripping siloxanes, VOCs, and HVOCs from biogas preferably by using adsorption on activated carbon, molecular sieves or, polymer beds; biogas stripping unit 102 is operative for stripping steam, VOCs, and HVOCs from biogas by use of a cold trap, or chemical abatement to remove VOCs and HVOCs.

Biogas stripping unit 102, which receives biogas having the chemical composition set forth hereinabove, preferably provides an output having the chemical composition shown in Table 2.

TABLE 2

| Gas | Concentration | |
|---|---|---|
| CH₄ and other hydrocarbons | 25-75 | mol % |
| CO₂ | 25-75 | mol % |
| H₂S | <3 | ppm |
| H₂O | ppm level | |
| SILOXANE | <3 | mg/m³ |

| | |
|---|---|
| VOLATILE ORGANIC COMPOUNDS | ppb level |
| OTHER THAN HYDROCARBONS | |
| HALOGENATED VOLATILE ORGANIC | ppb level |
| COMPOUNDS | |

The molar percentage of hydrocarbons and carbon dioxide contained in the output of biogas stripping unit 102 is sensed by a sensor 106, such as an IR (infra-red) gas analyzer measuring the molar percentage of methane, of other hydrocarbons, such as ethane, propane, and butane, if present, and of carbon dioxide. The output of biogas stripping unit 102 is supplied to a gas compressor 108, which compresses the output of biogas stripping unit 101, preferably to a pressure of 2-200 bar and most preferably to about 10 bar. The compressed output of biogas stripping unit 102 is preferably stored in a tank 110.

A solar radiation receiving reactor 120, such as a reactor described inter alia in the above-referenced U.S. Pat. No. 6,516,794, U.S. Pat. No. 6,003,508, and U.S. Pat. No. 5,931,158, the disclosures of which are hereby incorporated by reference, receives the compressed output of the biogas stripping unit 102 from the storage tank 110, via a control valve 112 and a conduit 121, preferably at a pressure of between 2-200 bar, and most preferably at a pressure of about 10 bar.

One or both of steam and carbon dioxide may be added, preferably at conduit 121, to the compressed output of the biogas stripping unit 102 supplied to reactor 120 depending on the chemical composition of the output of the biogas stripping unit 102, as sensed by sensor 106 and processed by a controller 122. Preferably, if the molar ratio of carbon dioxide to hydrocarbons, as calculated by controller 122 from the molar percentage of carbon dioxide and hydrocarbons in the biogas measured by sensor 106, is less than a preferred molar ratio, typically between 3:1 and 1.05:1, oxygen may be added by means of adding either steam or carbon dioxide. Normally steam is preferred due to its greater availability and lower cost. Valve 123, which is controlled by controller 122, preferably governs the supply of steam and/or carbon dioxide to conduit 121. Alternatively, the supply of steam and/or carbon dioxide may be governed by separate valves, which are controlled by controller 122.

Preferably, solar radiation is highly concentrated prior to impinging on solar radiation receiving reactor 120. Concentration of the solar radiation is preferably provided by directing incoming solar radiation through a concentrator 125. Concentrator 125 may have various possible configurations such as those described inter cilia in the above-referenced publications of Kribus, A., Zaibel, R., Carey, D. Segal, A., Karni, J. 1998, “A solar-driven combined cycle power plant”, Solar Energy 62{4121-129, and Mills, D., 2004, “Advances in solar thermal electricity technology”, Solar Energy 76:19-31, the disclosures of which are hereby incorporated by reference. The output of concentrator 125 is directed through a window 126 of the solar radiation receiving reactor 120 so as to impinge onto a surface 127 of solar radiation absorbing catalytic element 128 located therein. Window 126 is preferably formed of quartz and may be of any suitable shape such as flat or curved. Solar reactors having concave, generally conical windows, described in the above-referenced U.S. Pat. No. 5,931,158, and U.S. Pat. No. 6,516,794 may be suitable for this purpose.

Solar radiation absorbing catalytic element 128 may employ any suitable catalyst. The most preferred catalysts are Ruthenium and Rhodium. A somewhat less preferred catalyst is Iridium and even less preferred catalysts are Nickel, Platinum and Palladium. These catalysts are preferably applied over a pigmented wash coat which is deposited on highly porous support structures such as ceramic matrices, preferably formed of silicon carbide or alumina, as described inter alia in the above-referenced publications of Woerner, A., and Tamme, R., 1998, “CO₂ reforming of methane in a solar driven volumetric receiver-reactor” Catalysis Today 46:165-174, Berman, A., Karn, R. K., Epstein, M., 2005, “Kinetics of steam reforming of methane on Ru/Al₂0₃ catalysts promoted with Mn oxides”, Applied catalysis A: General 282:73-83, and. U.S. Pat. No. 5,431,855, the disclosures of which are hereby incorporated by reference.

The compressed output of biogas stripping unit 102 and any added steam and/or carbon dioxide, supplied to reactor 120 via a supply conduit 121, preferably is caused to impinge on surface 127 of the solar radiation absorbing catalytic element 128. In a preferred embodiment, conduit 121 extends into the reactor 120 and into close proximity with surface 127 of the solar radiation absorbing catalytic element 128. Alternatively, conduit 121 may not necessarily extend into the reactor 120, and the compressed output of biogas stripping unit 102 and any added steam and/or carbon dioxide may be caused to impinge on surface 127 of solar radiation absorbing catalytic element 128 by another suitable method.

The solar radiation absorbing catalytic element 128 is operative to cause the biogas to be reformed in reactor 120 principally in the following reaction:

CH₄+CO₂=2CO+2H₂ ΔH_{298K}=247 kJ

If steam is added to the reactor, such as in the case of insufficient carbon dioxide being present, the following additional reaction takes place:

CH₄+H₂O(g)=CO+3H₂ ΔH_{298K}=206 kJ

Reactions of this type are described in the above-referenced publication of Kodama, T., Moriyama, T., Shimoyama, T., Gokon, N., Andou, H., Satou, N. 2006, “Ru/Ni—Mg—O catalyzed SiC-foam absorber for solar reforming receiver-reactor”, Journal of Solar Energy Engineering 128:318-325, the disclosure of which is hereby incorporated by reference.

In accordance with a preferred embodiment of the present invention, window 126 can be cooled, as by a flow of cooling fluid, such as pressurized air from a nozzle 130 impinging on the outside surface 132 of window 126, thereby to prevent or reduce condensation of carbon on an inside surface 134 of window 126 and resultant reduction in the transparency thereof to incoming solar radiation and consequent excessive heating of the window 126.

The reformed biogas, mainly comprising carbon monoxide and hydrogen, is preferably supplied via a heat exchanger 136 to a reformed gas storage tank 138 and thence to any suitable utilization functionality, for example further processing into liquid fuels, such as methanol or biodiesel, direct use as feed gas for a gas turbine, turbo generator, or furnace, feeding into a natural gas pipeline, or producing “green” hydrogen for use in, for example, fuel cell powered cars. Heat exchanger 136 may provide preheating of the compressed output of biogas stripping unit 102 and any added steam and/or carbon dioxide along conduit 121, or may be used for any other suitable purpose.

In accordance with a preferred embodiment of the present invention, the reformed biogas is supplied to a user preferably via a reformed biogas stripping unit 139 that removes excess water and/or carbon dioxide from the reformed biogas and via a certification system 140, comprising a sensor 142. Sensor 142 may include a gas composition measuring device 143 such as a gas chromatograph or an infrared gas analyzer, operative for ascertaining the chemical composition of the reformed biogas, and a flow controller 144, operative for controlling the flow rate of the reformed biogas. The elements of the certification system 140 are preferably secured in a tamper-proof housing under lock and seal. The certification system 140 supplies the user with accurate data concerning the amount and composition of the solar reformed biogas.

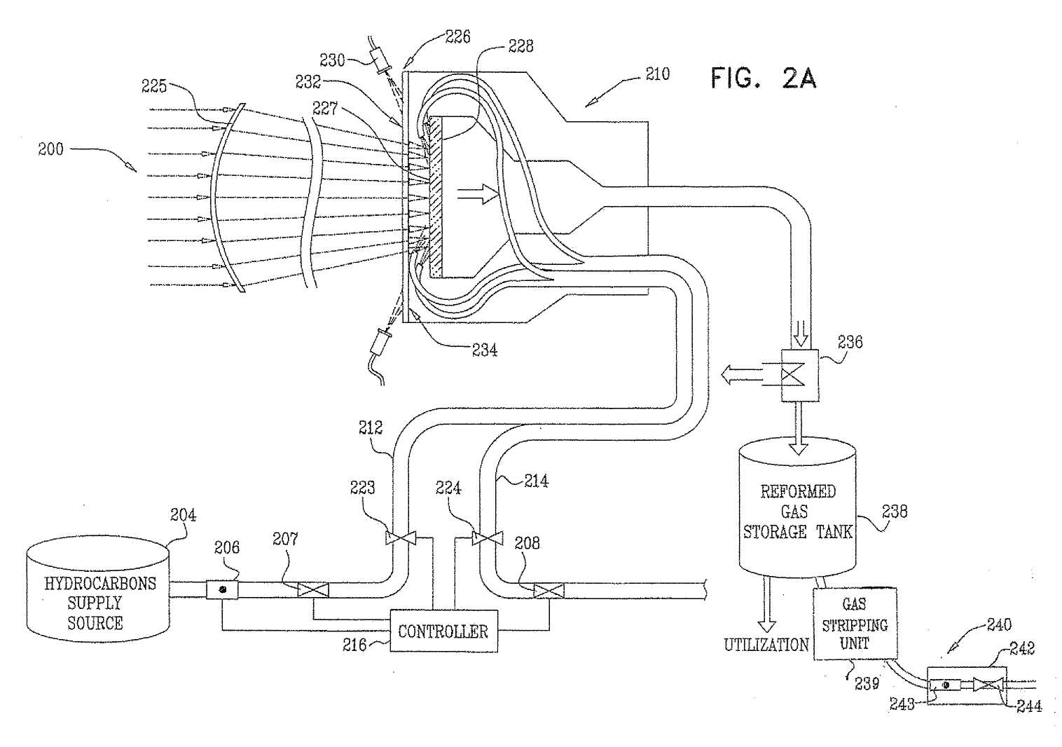

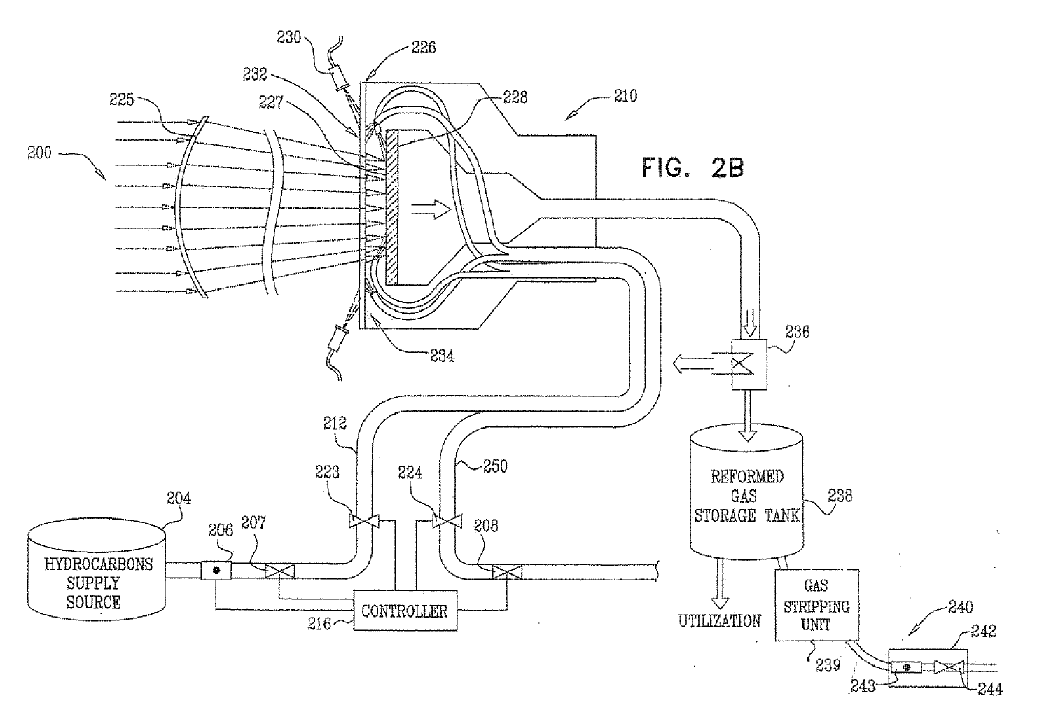

Reference is now made to FIGS. 2A and 2B, which are simplified partial block diagrams, partial schematic illustrations of a system for reforming hydrocarbon gas, constructed and operative in accordance with preferred embodiments of the present invention.

As seen in FIG. 2A, the present invention provides a system 200 for reforming hydrocarbon gas, which receives hydrocarbon gas from a hydrocarbon gas supply source 204, such as a natural gas pipeline. For the purpose of the present specification and claims, the term “hydrocarbon gas” is taken to mean any gas or mixture of gases which includes a hydrocarbon gas, with or without gaseous impurities of a type and/or quantity which would normally interfere with efficient catalyzed reforming absent stripping.

A preferred embodiment of the present invention is capable of reforming, e.g. increasing the calorific value of, hydrocarbon gas, employs solar energy for this purpose, and employs cost and energy efficient techniques to prevent coking.

In a preferred embodiment of the present invention, the hydrocarbon supply source 204 is a storage tank which receives hydrocarbon gas preferably from natural gas pipelines. A typical chemical composition of the hydrocarbon gas is shown in Table 3 but can vary depending on the source.

TABLE 3

| | Typical Analysis | Range |
|---|---|---|
| Component | (molar %) | (molar %) |
| Methane | 94.9 | 87.0-96.0 |
| Ethane | 2.5 | 1.8-5.1 |
| Propane | 0.2 | 0.1-1.5 |
| iso - Butane | 0.03 | 0.01-0.3 |
| Normal - Butane | 0.03 | 0.01-0.3 |
| iso - Pentane | 0.01 | trace-0.14 |
| Normal - Pentane | 0.01 | trace-0.04 |
| Hexanes plus | 0.01 | trace-0.06 |
| Nitrogen | 1.6 | 1.3-5.6 |
| Carbon Dioxide | 0.7 | 0.1-1.0 |
| Oxygen | 0.02 | 0.01-0.1 |
| Hydrogen | trace | trace-0.02 |

The molar percentage of hydrocarbons contained in the output of the hydrocarbon gas supply source 204 is sensed by a sensor 206, such as an IR (infra-red) gas analyzer measuring the molar percentage of methane, and of other hydrocarbons, such as ethane, propane and butane, if present. The flow rate of the output of the hydrocarbon gas supply source 204 is measured by a flow meter 207. Reactants for the reforming of the hydrocarbon gas are preferably steam and/or carbon dioxide which may be supplied from a supply pipe and the flow of steam and/or carbon dioxide is measured by a flow meter 208.

A solar radiation receiving reactor 210, such as a reactor described inter alia in the above-referenced U.S. Pat. No. 6,516,794, U.S. Pat. No. 6,003,508, and U.S. Pat. No. 5,931,158, the disclosures of which are hereby incorporated by reference, receives hydrocarbon gas from the hydrocarbon gas supply source 204, via a conduit 212, preferably at a pressure of between 2-20 bar, and most preferably at a pressure of about 10 bar, and steam and/or carbon dioxide via a conduit 214, preferably adjusted to the same pressure as that of the hydrocarbon gas.

The molar ratio of steam and/or carbon dioxide to hydrocarbons is controlled by controller 216 from the molar percentage of hydrocarbons in the output of hydrocarbon gas supply source 204 as sensed by sensor 206, and from the flow of hydrocarbon gas and steam or carbon dioxide as measured by now meters 207 and 208. Preferably, the flow rate and the molar ratio of steam and/or carbon dioxide to hydrocarbons is adjusted to be within a preferred range, typically between 3:1 and 1.05:1 by valves 223 and 224, which are controlled by controller 216

Preferably, solar radiation is highly concentrated prior to impinging on solar radiation receiving reactor 210. Concentration of the solar radiation is preferably provided by directing incoming solar radiation through a concentrator 225. Concentrator 225 may have various possible configurations such as those described inter alia in the above-referenced publications of Kribus, A., Zaibel, R., Carey, D. Segal, A., Karni, J. 1998, “A solar-driven combined cycle power plant”, Solar Energy 62(2):121-129, and Mills, D., 2004, “Advances in solar thermal electricity technology”, Solar Energy 76:19-31, the disclosures of which are hereby incorporated by reference. The output of concentrator 225 is directed through a window 226 of the solar radiation receiving reactor 210 so as to impinge onto a surface 227 of solar radiation absorbing catalytic element 228 located therein. Window 226 is preferably formed of quartz and may be of any suitable shape such as flat or curved. Solar reactors having concave, generally conical windows, described in the above-referenced U.S. Pat. No. 5,931,158, and U.S. Pat. No. 6,516,794 may be suitable for this purpose.

Solar radiation absorbing catalytic element 228 may employ any suitable catalyst. The most preferred catalysts are Ruthenium and Rhodium. A somewhat less preferred catalyst is Iridium and even less preferred catalysts are Nickel, Platinum and Palladium. These catalysts are preferably applied over a pigmented wash coat which is deposited on highly porous support structures such as ceramic matrices, preferably formed of silicon carbide or alumina, as described inter cilia in the above-referenced publications of Woerner, A., and. Tamme, R., 1998, “CO₂ reforming of methane in a solar driven volumetric receiver-reactor” Catalysis Today 46:165-174, Berman, A., Karn, R. K., Epstein, M., 2005, “Kinetics of steam reforming of methane on Ru/Al₂0₃ catalysts promoted with Mn oxides”, Applied catalysis A: General 282:73-83, and U.S. Pat. No. 5,431,855, the disclosures of which are hereby incorporated by reference.

In accordance with a preferred embodiment of the present invention, the hydrocarbon gas from hydrocarbon gas supply source 204 supplied to reactor 210 via a hydrocarbon gas supply conduit 212, and the steam and/or carbon dioxide supplied to reactor 210 via steam/carbon dioxide supply conduit 214 are preferably caused to impinge on surface 227 of the solar radiation absorbing catalytic element 228. For example, conduits 212 and 214 extend into the reactor 210 and into close proximity with surface 227 of the solar radiation absorbing catalytic element 228. Alternatively, conduits 212 and 214 may not necessarily extend into the reactor 210, and the hydrocarbon gas and steam and/or carbon dioxide may be caused to impinge on surface 227 of solar radiation absorbing catalytic element 228 by another suitable method.

The solar radiation absorbing catalytic element 228 is operative to cause the hydrocarbon gas to be reformed in reactor 210 in one of the following reactions:

When the oxygen source is carbon dioxide then the main reaction is:

CH₄+CO₂=2CO+2H₂ ΔH_{298K}=247 kJ

When the oxygen source is steam, then the main reaction is:

CH₄+H₂O(g)=CO+3H₂ ΔH_{298K}=206 kJ

Reactions of this type are described in the above-referenced publication of Berman, A., Karn, R. K., Epstein, M., 2005, “Kinetics of steam reforming of methane on Ru/Al₂0₃ catalysts promoted with Mn oxides”. Applied catalysis A: General 282:73-83. and Klein, H. H., Karni, J., Rubin, R., 2009, “Dry Methane Reforming Without a Metal Catalyst in a Directly Irradiated Solar Particle Reactor” J. of Solar Energy Engineering, Vol. 131, 021001-1-14, the disclosure of which is hereby incorporated by reference.

Preferably, window 226 is cooled by a flow of cooling fluid, such as pressurized air from a nozzle 230 impinging on the outside surface 232 of window 226, thereby to prevent or reduce condensation of carbon on an inside surface 234 of window 226 and resultant reduction in the transparency thereof to incoming solar radiation and consequent excessive heating of the window 226.

The reformed gas, mainly comprising carbon monoxide and hydrogen, is preferably supplied via a heat exchanger 236 to a reformed gas storage tank 238 and thence to any suitable utilization functionality, for example, further processing into liquid fuel such as methanol, direct use as feed gas for a gas turbine, turbo generator, or furnace, feeding into a natural gas pipeline, or producing hydrogen for use in for example fuel cell powered cars. Heat exchanger 236 may provide preheating of the incoming gases in conduits 212 and 214 or may be used for any other suitable purpose.

In accordance with a preferred embodiment of the present invention, the reformed gas is supplied to a user preferably via a reformed gas stripping unit 239 that removes excess water and/or carbon dioxide and via a certification system 240, comprising at least a sensor 242. Sensor 242 includes elements such as a measuring device (e.g. a gas chromatograph or an infrared gas analyzer) 243 for ascertaining the chemical composition of the reformed gas, and a flow controller 244 for controlling the reformed gas flow rate. The elements of the certification system 240 are preferably secured in a tamper-proof housing under lock and seal. The certification system 240 supplies the user with accurate data concerning the amount and composition of the solar reformed gas.

Turning now to FIG. 2B, which is an illustration of a preferred embodiment of the present invention, it is noted that FIG. 2B is similar to FIG. 2A and identical features are indicated by the same reference numerals as appear in FIG. 2A.

As seen in FIG. 2B, steam and/or carbon dioxide supplied to the reactor 210 via steam/carbon dioxide supply conduit 250 is preferably caused to flow alongside inside surface 234 of window 226. In a preferred embodiment, conduit 250 extends into the reactor 210 and into close proximity with inside surface 234 of window 226. Alternatively, conduit 250 may not necessarily extend into the reactor 210, and steam and/or carbon dioxide may be caused to flow alongside inside surface 234 of window 226 by another suitable method. Flow of steam and/or carbon dioxide along inside surface 234 of window 226 generally excludes the presence of hydrocarbon gas thereat, thereby preventing or reducing condensation of carbon on an inside surface 234 of window 226, and resultant reduction in the transparency thereof to incoming solar radiation and consequent excessive heating of the window 226.

It will be appreciated by persons skilled in the art that the present invention is not limited by what has been particularly shown and described hereinabove. Rather the scope of the present invention includes both combinations and sub-combinations of various feature of the invention and modifications thereof which may occur to persons skilled in the art upon reading the foregoing description and which are not in the prior art.

1. A method for reforming hydrocarbon gas, the method comprising:
stripping from the hydrocarbon gas at least most of gaseous impurities selected from the group consisting of hydrogen sulfide, siloxanes, volatile organic compounds other than hydrocarbons, and halogenated volatile organic compounds, in order to provide stripped hydrocarbon gas including carbon dioxide; and
reacting the stripped biogas in a solar radiation receiving reactor having a catalyst that is heated by concentrated solar radiation impinging thereon, thereby providing an output gas mixture comprising hydrogen gas and carbon monoxide.

2. A method for reforming hydrocarbon gas according to claim 1, further comprising:
compressing the stripped biogas, to provide compressed stripped biogas, prior to said reacting.

3. A method for reforming hydrocarbon gas according to claim 1 and also comprising:
adding at least one of steam and carbon dioxide to said stripped hydrocarbon gas when the molar ratio of carbon dioxide to hydrocarbon gas in said stripped hydrocarbon gas is below a preferred molar ratio, thereby providing oxygen-enhanced stripped hydrocarbon gas for supply to said solar radiation receiving reactor.

4. A method for reforming hydrocarbon gas according to claim 1 and wherein said solar radiation receiving reactor includes a solar radiation transparent window for allowing said solar radiation to impinge on said catalyst, the method also comprising cooling said solar radiation transparent window to help prevent deposition of carbon thereon.

5. A method for reforming hydrocarbon gas according to claim 1 and wherein said stripping includes adsorption on at least one material selected from the group consisting of activated carbon, alumina, clay, ZnO nanoparticles, molecular sieves, and polymer beds.

6. A method for reforming hydrocarbon gas according to claim 1 and wherein said stripping includes the use of water or a liquid catalyst containing ferric ions.

7. A method for reforming hydrocarbon gas according to claim 1 and wherein said stripping includes the use of a cold trap.

8. A method for reforming hydrocarbon gas according to claim 1 and further comprising stripping excess water from said output gas mixture.

9. A method for reforming hydrocarbon gas according to claim 1 and further comprising stripping excess carbon dioxide from said output gas mixture.

10. A method for reforming hydrocarbon gas according to claim 1 and further comprising ascertaining a composition of said output gas mixture and controlling a flow rate of said output gas mixture.

11. A system for reforming hydrocarbon gas comprising:
a first stripping unit for stripping from the hydrocarbon gas at least most of gaseous impurities selected from the group consisting of hydrogen sulfide, siloxanes, volatile organic compounds other than hydrocarbons, and halogenated volatile organic compounds, in order to provide stripped hydrocarbon gas including CO₂;
a solar radiation receiving reactor for reacting the stripped hydrocarbon gas having a catalyst that is heated by concentrated solar radiation impinging thereon, thereby providing an output gas mixture comprising hydrogen gas and carbon monoxide.

12. A system for reforming hydrocarbon gas according to claim 11 and also comprising:
a compressor for compressing the stripped hydrocarbon gas to provide compressed stripped hydrocarbon gas.

13. A system for reforming hydrocarbon gas according to claim 11 and also comprising:
a conduit and a valve for adding at least one of steam and carbon, dioxide to said stripped hydrocarbon gas when the molar ratio of carbon dioxide to hydrocarbon gas in said stripped hydrocarbon gas is below a preferred molar ratio, thereby providing oxygen-enhanced stripped hydrocarbon gas for supply to said solar radiation receiving reactor.

14. A system for reforming hydrocarbon gas according to claim 11 and wherein said solar radiation receiving reactor includes a solar radiation transparent window for allowing said solar radiation to impinge on said catalyst, the system also comprising a mechanism for cooling said solar radiation transparent window to help prevent deposition of carbon thereon.

15. A system for reforming hydrocarbon gas according to claim 11 and wherein said first stripping unit employs adsorption on at least one material selected from the group consisting of activated carbon, alumina, clay, ZnO nanoparticles, molecular sieves, or polymer beds.

16. A system for reforming hydrocarbon gas according to claim 11 and wherein said first stripping unit employs water or a liquid catalyst containing ferric ions.

17. A system for reforming hydrocarbon gas according to claim 11 and wherein said first stripping unit includes a cold trap.

18. A system for reforming hydrocarbon gas according to claim 11 and also comprising:
a second stripping unit for stripping excess water from said output gas mixture.

19. A system for reforming hydrocarbon gas according to claim 11 and also comprising:
a second stripping unit for stripping excess carbon dioxide from said output gas mixture.

20. A system for reforming hydrocarbon gas according to claim 11 and also comprising:
a mechanism for ascertaining a chemical composition of said output gas mixture; and
a flow controller for controlling a flow rate of said output gas mixture.

21. A method for reforming hydrocarbon gas, the method comprising:
reacting the hydrocarbon gas with at least one of steam and carbon dioxide in a solar radiation receiving reactor which includes a catalyst and a solar radiation transparent window for allowing concentrated solar radiation to impinge directly on said catalyst, thereby providing an output gas mixture comprising hydrogen gas and carbon monoxide; and
maintaining transparency of said window to said concentrated solar radiation by at least one of:
controlling a molar ratio of the hydrocarbon gas to said at least one of steam and carbon dioxide in said reactor in order to provide a generally equal presence of the hydrocarbon gas and said at least one of steam and carbon dioxide by molar percentage;
cooling said window; and
causing said at least one of steam and carbon dioxide to flow alongside said window, generally to exclude the presence of the hydrocarbon gas thereat.

22. A method for reforming hydrocarbon gas according to claim 21 and further comprising ascertaining a composition of said output gas mixture and controlling a flow rate of said output gas mixture.

23. A system for reforming hydrocarbon gas comprising:
a solar radiation receiving reactor which includes a catalyst and a solar radiation transparent window for allowing concentrated solar radiation to impinge directly on said catalyst, said reactor receiving the hydrocarbon gas and at least one of steam and carbon dioxide and providing an output gas mixture comprising hydrogen gas and carbon monoxide; and
a mechanism for maintaining transparency of said window to said concentrated solar radiation by at least one of:
controlling a molar ratio of the hydrocarbon gas to said at least one of steam and carbon dioxide in said reaction to provide a generally equal presence of the hydrocarbon gas and said at least one of steam and carbon dioxide by molar percentage;
cooling said window; and
causing said at least one of steam and carbon dioxide to flow alongside said window, generally to exclude the presence of the hydrocarbon gas thereat.

24. A system for reforming hydrocarbon gas according to claim 23 and also comprising:
a mechanism for ascertaining a chemical composition of said output gas mixture; and
a flow controller for controlling a flow rate of said output gas mixture.

25. A system for reforming hydrocarbon gas comprising:
a solar radiation receiving reactor that receives the hydrocarbon gas and at least one of steam and carbon dioxide and provides an output gas mixture that includes hydrogen gas and carbon monoxide; and
a certification system for certifying an amount and composition of said output gas mixture.

26. A system for reforming hydrocarbon gas according to claim 25 wherein said certification system includes a mechanism for ascertaining said composition of said output gas mixture and a flow controller for controlling a flow rate of said output gas mixture.

27. A system for reforming hydrocarbon gas according to claim 26, wherein said mechanism for ascertaining said composition of said output gas mixture includes a measuring device selected from the group consisting of a gas chromatograph and an infrared gas analyzer.

28. A system for reforming hydrocarbon gas according to claim 25 further comprising a tamper-proof housing for securing said certification system.
